(19) United States
(12) Patent Application Publication
(10) Pub. No.: US 2017/0176313 A1
(43) Pub. Date: Jun. 22, 2017

(54) INSPECTION METHOD FOR EARLY WARNING SYSTEM OF INDUSTRIAL SECURITY

(71) Applicant: WIDAX TECHNOLOGY CORP, Taipei (TW)

(72) Inventors: Chun-Ming YU, Taipei (TW); Shun-Yang KO, Taipei (TW)

(21) Appl. No.: 14/975,259

(22) Filed: Dec. 18, 2015

(51) Int. Cl. G01N 15/06; G01M 99/00

(52) U.S. Cl. CPC G01N 15/0656; G01M 99/002

(57) ABSTRACT

The present invention discloses an inspection method for early warning system of industrial security, in which the inspection steps for early warning system comprises: using inspection tool to collect signal characteristics regarding periphery of predetermined area; calculating on collected signal characteristics by means of processor in inspection tool through predetermined programs; determining, based on calculation results, error point of signal characteristics by means of processor in inspection tool; determining the time that abnormal phenomenon is about to occur by means of processor in accordance with data of error point, sending out warning information, and also transmitting collected signal characteristics via wireless transmission unit; and receiving characteristics information transmitted by wireless transmission unit by using wireless transceiver unit and then storing in built-in database for subsequent comparisons. The purposes of early and accurate factory security inspections as well as reduction in possibility for occurrence of accidents can be successfully achieved.

### BACKGROUND OF THE INVENTION

1. Field of the Invention

The present invention provides an inspection method for early warning system of industrial security; in particular, it relates to a method capable of inspecting various equipments in an industrial factory area such that, by way of various references, e.g., based on temperature, humidity, air concentration, or otherwise foreign substance or dust contents in the air and the like, in the inspection area, it is possible to determine the time for the occurrence of an abnormal phenomenon via calculations in order to effectively achieve the objectives of accident prevention and loss reduction.

2. Description of Related Art

Everyone knows that the center of human activities has already evolved from traditional agricultural operations into industrial developments, then further stepping towards the technology epoch, thus creating countless industrial and technical products which facilitate better and more efficient progresses in people's living and working environments. To respond to the advancement in the industrial and technical times, countless tooling machines, industrial facilities, high-tech factories or the like have been set up such that, through various automatic production processes as well as fast and precise manufacturing operations, many industrial and technical products can be fabricated in order to satisfy the demand of modern people. Also, to successfully elevate the production throughput, such industrial facilities or high-tech factories etc. may need to keep expanding or increasing their factory areas, tooling machines and working mother machines and so on thereby improving the manufacturing operation models via the mass production approach and accelerating the product fabrication flows so as to manufacture products in a large scale within shorter work time thus fulfilling the economical effectiveness. However, in modern industrial or high-tech factories, due to various types of tools, manufacturing machines and apparatuses or the like, relevant facilities and installations, e.g., clean (dust-free) rooms, control centers, central air-conditioning systems and processing equipments for different kinds of waste air or water, are also required. Therefore, in such industrial or high-tech factories, it is common that people may schedule regular security inspections within a certain duration of time (such as, once every half a year or annually) for the manufacture areas, tooling machines or other equipments etc. installed within the factory, thereby comprehensively and correctly realizing whether such equipments and machines conform to relevant industrial security standards thus reducing the possibility of accidents occurring in the factory- so as to prevent serious damages or losses, which is also the reason that strict regulations and improvements have been continuously urged by the government for the purpose of industrial security quality.

On the other hand, for objects generally existing in the natural world, electro-magnetic waves may be emitted so long as the temperature generated there from is higher than the absolute zero degree. The operational principle of, for example, a currently available thermo-imaging device for detecting the temperature can determine the temperature of an object by analyzing the distribution of energy density in infrared (IR) radiation emitted from the surface of the object. By comparing the IR image with background temperature, it is possible to use the thermo-imaging graph showing the abnormally increased temperature typically found in a malfunctioned electronic component so as to analyze the temperature variation of the inspected object. The operation modes currently utilized in temperature detection applications of industrial security may be, respectively, the non-contact-typed IR thermo-imaging device or the contact-typed thermo-couple temperature probe, etc. During industrial security inspections, inspection personnel equipped with a non-contact thermo-imaging device usually will be dispatched to scan the electric power distribution system or distribution board in various factories and facilities so as to detect any abnormal condition in terms of temperature. Whereas, this kind of scan operations could be pretty time-consuming and require a lot of human efforts to complete, so it is common that the manufacture companies may schedule the inspection procedures once in every 3 or 6 months, but the “window” there between where no scans are executed may undesirably turn into a “blind spot” for industrial security. In case an accidental event somehow really occurs, the production line may be forced to stop or otherwise the equipments and factory may be damaged, which may cause losses possibly beyond estimation.

Furthermore, due to large factory areas and a great number of various machines and apparatuses in modern industrial factories or high-tech factories, upon performing the industrial security inspection, the inspection staffs may need to examine each of the areas and machines in the factory one by one, which may take a long time and a great deal of manpower, thus adversely affecting the production schedules for relevant equipments and tooling machines or so forth. Besides, most of the industrial security inspections are done within the visible range of the inspection personnel's eyesight, but other electro-mechanic devices and control components or systems etc. installed inside these equipments or machines still require more sophisticated instruments to be checked. As a result, a single inspection process may inevitably cost a significant amount of manpower and budgets, so the industrial security inspection on various factories may be procrastinated for a longer time, or otherwise people just execute some simpler inspection operations. But, it should be noticed that, no matter detailed or simplified industrial security inspections, none of them can provide an early warning feature, and this sort of compromise in industrial security inspections may eventually result in significant casualties and huge damages once a horrible accident does happen. Consequently, there still exist many problems and challenges to be resolved in the field of industrial security inspections.

Accordingly, to find solutions to effectively solve the issues and problems concerning time consumption and significant efforts for performing industrial security inspections in various factories, the absence of early warning feature from current industrial inspection operations, and also the incapability and difficulties for possible prevention processes in advance, have now become the objective to be achieved and enhanced for relevant professions and industries.

### SUMMARY OF THE INVENTION

As such, with regards to the above-said issues and drawbacks, the inventors of the present invention have collected related information, devoted numerous efforts in evaluations and considerations, in addition to long-termed experiences in such professional fields and continuous tries and modifications, thus devising the industrial security inspection method for factories as disclosed in the present invention. By means of the inspection method for early warning system of industrial security according to the present invention, it is possible to execute inspections having higher precision, and determine the time that an abnormal phenomenon or event may occur thereby allowing to take precautionary measures beforehand and reduce the possibility of accidents.

The primary objective of the present invention lies in that the inspection steps for the early warning system according to the present invention comprises: using an inspection tool to collect relevant signal characteristics with regards to the periphery of a predetermined area; calculating on the collected signal characteristics by means of a processor in the inspection tool through the predetermined programs; determining, based on the calculation results, the error point of the signal characteristics by means of the processor in the inspection tool; determining the time that an abnormal phenomenon is about to occur by means of the processor in accordance with the data of the error point, sending out the warning information in advance, and also transmitting the collected signal characteristics via a wireless transmission unit; and receiving the warning information for the signal characteristics transmitted by the wireless transmission unit by using a wireless transceiver unit of the inspection device and then storing in a built-in database for subsequent comparisons; in this way, the objectives on precise and correct early warning for industrial factory security, reduction in industrial security accidents and elevated production yields in each of production stages can be successfully achieved.

In addition, the secondary objective of the present invention is that, the inspection operation according to the present invention applies the inspection tool to examine relevant equipments, tooling machines, chemical pipelines or the like in a factory and uses the predetermined programs to perform the Z-transform formula as below by means of the built-in processor (e.g., a central processing unit (CPU), a microprocessor or a chip etc.):

$$X ( z ) = Z \{ x ( n ) \} = {\sum }_{n = 0}^{∞} x ( n ) {z}^{- n .} ,$$

thereby calculating and converting onto a different vector plane to determine the time that an abnormality in the inspection characteristic signals may appear and provide a warning message thus allowing to take preventive measures in advance.

Yet another objective of the present invention exists in that, through the wireless transmission unit connected to the processor, the inspection tool may transfer the characteristic signal of the inspection to the wireless transceiver unit in the inspection device via wireless communications to perform transmissions. The wireless transmissions between the wireless transmission unit and the wireless transceiver unit may be of Zigbee, Z-wave, Bluetooth, Wi-Fi, WiMAX, light communication or Sub-G

### BRIEF DESCRIPTION OF THE DRAWINGS

FIG. 1 shows a flowchart of the present invention.

FIG. 2 shows a block diagram of the present invention.

FIG. 3 shows a coordinate graph of variations in environmental temperature according to the present invention.

FIG. 4 shows a curve graph of variations in environmental temperature according to the present invention.

FIG. 5 shows a partial enlargement view for the Portion A in FIG. 4 according to the present invention.

### DETAILED DESCRIPTION OF THE PREFERRED EMBODIMENTS

To achieve the aforementioned objective and effects, with regards to the technical means and structures as well as implementation methods utilized in the present invention, the characteristics and functions thereof will be hereunder set forth in details by means of preferred embodiments of the present invention along with appended drawings so as to comprehensively understand the present invention.

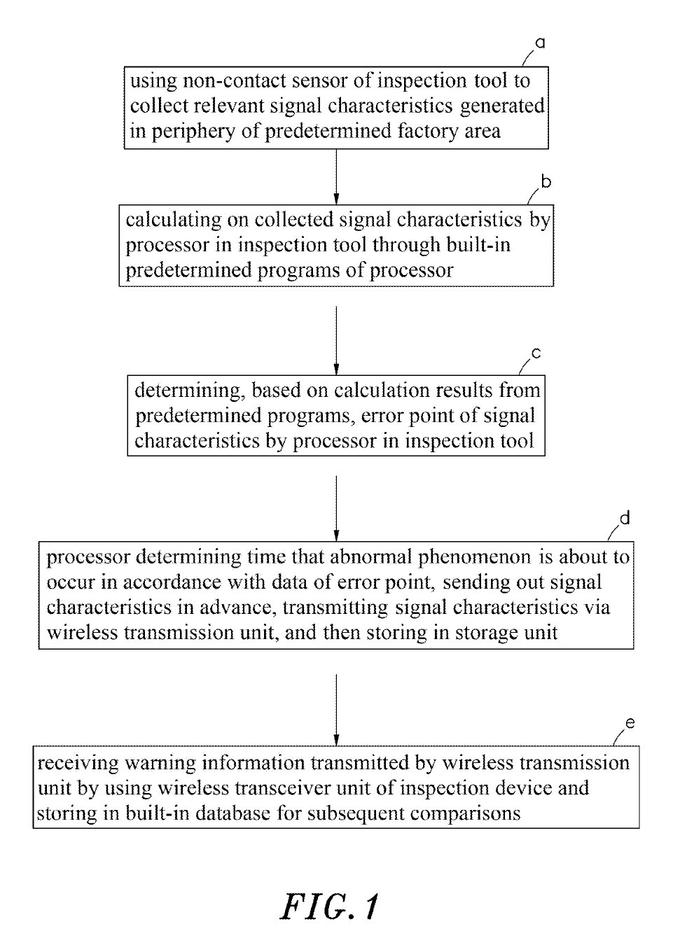

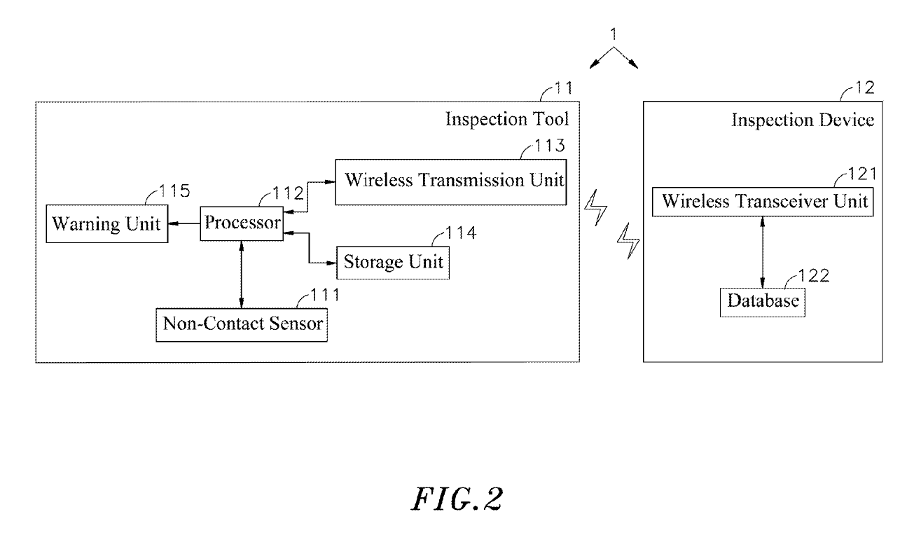

Refer first to FIGS. 1 and 2, wherein a flowchart and a block diagram of the present invention are respectively shown. It can be clearly seen from the Figures that, in the inspection method for early warning system of industrial security according to the present invention, an early warning system 1 comprises an inspection tool 11 and an inspection device 12 in order to perform inspection processes including the following steps:

(a) using a non-contact sensor 111 of the inspection tool 11 to collect relevant signal characteristics with regards to the periphery of a predetermined area in a factory;

(b) calculating on the collected signal characteristics by means of a processor 112 in the inspection tool 11 through the built-in predetermined programs of the processor 112;

(c) determining, based on the calculation results from the predetermined programs, the error point of the signal characteristics by means of the processor 112 in the inspection tool 11;

(d) the processor 112 determining the time that an abnormal phenomenon is about to occur in accordance with the data of the error point, sending out the signal characteristics in advance, transmitting the signal characteristics via a wireless transmission unit 113, and then storing in a storage unit 114; and

(e) receiving the warning information transmitted by the wireless transmission unit 113 by using a wireless transceiver unit 121 of the inspection device 12 and storing in a built-in database 122 for subsequent comparisons.

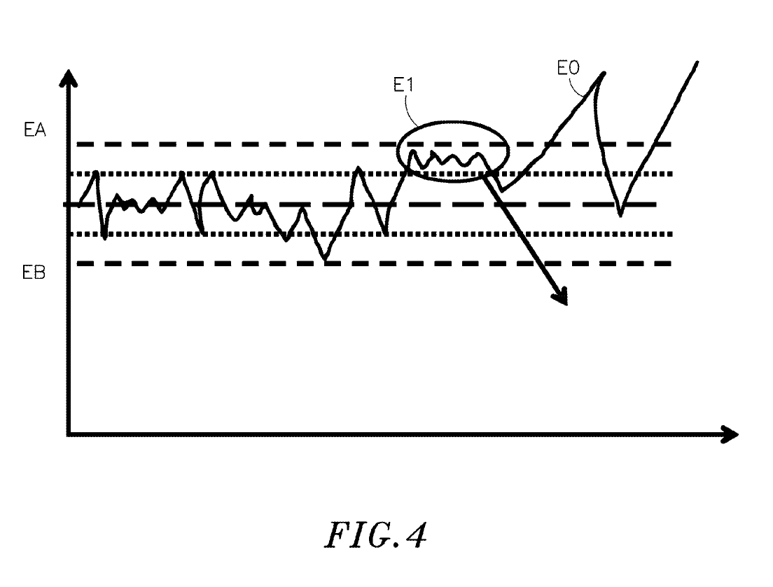

Next, refer conjunctively to FIGS. 2, 3, 4 and 5, wherein a block diagram, a coordinate graph of variations in environmental temperature, a curve graph of variations in environmental temperature and a partial enlargement view for the Portion A in FIG. 4 according to the present invention are respectively shown. It can be clearly observed from the Figures that the non-contact sensor 111 of the inspection tool 11 may be an infrared (IR) sensor, a hygrometer, a photo-sensor, a dust monitor or an air detector etc. so as to, by using the non-contact sensor 111, detect relevant signal characteristics about the variations regarding to the temperature, humidity, air concentration or dust/impurity contents or the like in the surrounding range of a predetermined area (e.g., the central control room, the power distribution system, the air conditioning system, the machining tool, the working mother machine or the electrical apparatus in a factory or the like.) Then the signal characteristics detected by the non-contact sensor 111 can be transferred to the processor 112 (such as a central processing unit (CPU), a microprocessor or a chip etc.) or a cloud database thus allowing further analyses with the predetermined programs. The processor 112 can store the signal characteristics in the storage unit 114, and the built-in predetermined program of the processor 112 can perform the Z-transform formula, as below:

$$X ( z ) = Z \{ x ( n ) \} = {\sum }_{n = 0}^{∞} x ( n ) {z}^{- n .} ,$$

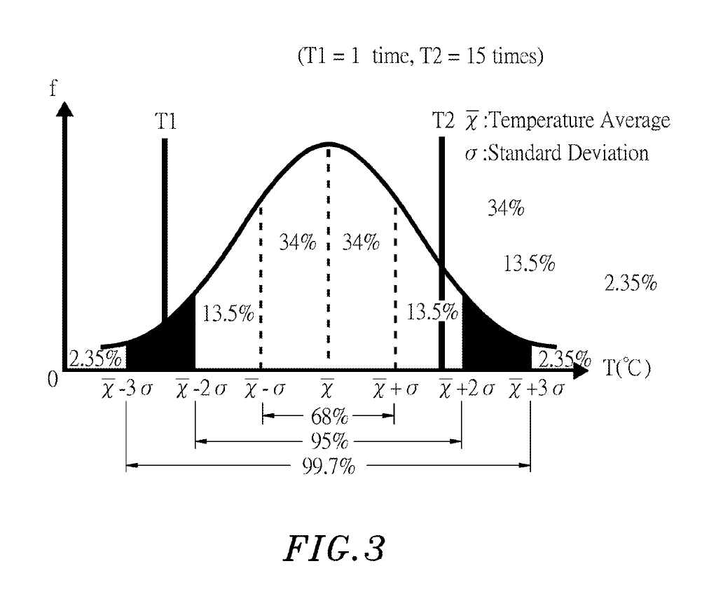

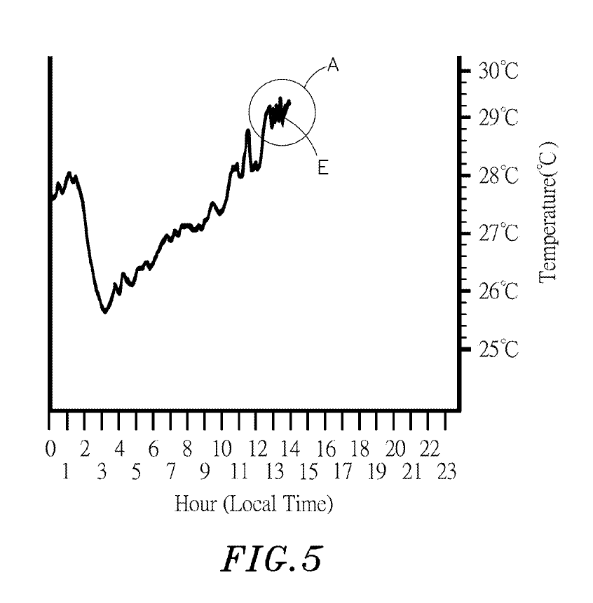

to calculate, and then analyze and determine such obtained results based on a curve graph. FIG. 3 shows a general determination approach. The warning point can be configured in accordance with the Gauss distribution exhibited by the temperature statistics, in which the system setup X may issue a warning signal if “29 degrees” has been surpassed by 3 degrees fifteen (15) times (i.e., T2 position) or alternatively the Max/Min limits have been surpassed by 10 degrees one (1) time (i.e., T1 position.) Herein, during the analysis operation, it can be based on the occurrence of an error point position (E) due to increase in temperature (it is possible to set the abnormal signal characteristic as upon the temperature exceeding 29° C.); then, through this error point position, it is possible to further apply the vector plane conversion or Z-transform to analyze the significant variation in temperature (shown as E₁ in FIG. 5) to appreciate in advance that the occurrence of an abnormal signal (E₀) is imminent. Furthermore, according to a priori analyses, it can be comprehended that the temperature signal characteristics in the inspection area are about to change abnormally, so the processor 112 in the inspection tool 11 may, based on the analysis results, issue a warning message through a warning unit 115 (e.g., an alarm lamp, a buzzer or a speaker or a microphone for communication etc.) thereby allowing relevant staffs or personnel in that area to deal with such situations to prevent accidents and reduce the possibility of occurrence of potentially dangerous events in order to effectively achieve the industrial security premonitory function.

The inspection tool 11 can be used to detect each area in a factory individually, and the analysis signals obtained from the variations generated by various environmental signal characteristics (e.g., temperature, humidity, air concentration or dust/powder impurities etc.) in that area by means of the non-contact sensor 111 of the inspection tool 11 can be transferred to the inspection device 12 via the wireless transmission unit 113 such that the wireless transceiver unit 121 in the inspection device 12 receives the analysis signals sent by the wireless transmission unit 113. In addition, the wireless signals transferred between the wireless transmission unit 113 and the wireless transceiver unit 121 may be wireless signals conforming to Zigbee, Z-wave, Bluetooth, Wi-Fi, WiMAX, light communication or Sub-G and so forth. The inspection device 112 may store the received analysis signals in the database 122 such that, during the next inspection operation on the same area, the inspection device 12 may transfer the analysis signals related to that area to the wireless transmission unit 113 via the wireless transceiver unit 121, so that the processor 112 in the inspection tool 11 can receive the analysis signals of previous inspections and then compare them with the currently acquired analysis signals or the signal characteristics saved in the storage unit 114 in order to determine the occurrence of abnormal phenomena in the environment of that area through analysis signal comparisons to seek appearance of significant variations, thus allowing the inspection staffs to more precisely appreciate and control any changes in the environmental signal characteristics of the inspection area. Of course, the analysis signals provided by the aforementioned processor 112 can be re-evaluated in the database 122 again in order to determine whether any abnormal change occurs in the surrounding range of the inspection area, and since the industrial inspection is performed through the non-contact sensor 111 of the inspection tool 11 in each area of the factory or facilities, this may require less manpower and lower budgets, thus offering advantages like time-saving, work-saving and economical effects, and also the inspection can be repeatedly performed within shorter period of time, thus enabling improved industrial security maintenance for industrial factories and reduced damages and losses caused by accidents. Besides, the storage unit 114 of the inspection tool 11 may store or install a certain preset programs such that, upon using the inspection tool 11 to executing inspections, the sampled temporary or backup data can be provided to the processor 112 as the reference for comparison and analysis operations.

The inspection tool 11 may be also applied to detect the temperature variations in a chemical pipeline. By monitoring the temperature deviation coefficient on the wall of the pipeline, the processor 112 may determine whether the chemical liquid therein is appropriate for subsequent processes under such a temperature fluctuation; in case the temperature deviates too much or becomes out of a suitable range, the chemical pipeline may stop delivering and a suitable heating or cooling operation may be executed in order to ensure the thermal reservation effect can be actually achieved for improved product yield rates.

Upon detecting relevant signal characteristics regarding to the variations in temperature, humidity, air concentration or dust/powder impurities etc. in the surrounding zone of the predetermined area (e.g., the central control room, the power distribution system, the air conditioning system, the machining tool, the working mother machine or the electrical apparatus or the like), certain issues like component aging problems in the machines or equipments within the inspection area or measurement deviations in the processor 112 of the inspection tool 11 might be ignored during inspection operations, but such issues could be critical information concerning the industrial security of the inspection area as well. Therefore, through various kinds of data stored in the database 122, the inspection device 12 can compare and analyze the environmental temperature, voltage, current and wireless signal intensity of the inspection area in order to further determine the differences between data signals thereby compensating the difference signals among the components within such tools or equipments and achieving the auto-correction function in the inspection tool 11. In this way, the inspection tool 11 may provide more precise deviation coefficient determinations and discover beforehand the fluctuations in the signal characteristics of the inspection area so as to send out a warning notice for precautionary measures.

Accordingly, the descriptions set forth as above all illustrate simply the preferred embodiments of the present invention, rather than restricting the scope of the present invention thereto. The inspection method for early warning system of industrial security according to the present invention provides an early warning system 1 comprising an inspection tool 11 and an inspection device 12, which uses the non-contact sensor 111 of the inspection tool 11 to perform environmental detections in a predetermined area, applies a processor 112 to analyze based on the detected signal characteristics (such as temperature, humidity or dust/powder densities etc.) in order to determine the time that an abnormal signal is about to appear thereby enabling relevant personnel or staffs in that area to take corresponding measures thus achieving the purpose of reducing the possibility of industrial security accidents. Moreover, it is possible to, through a wireless transmission unit 113 in the inspection tool 11, transfer the signal characteristics analyzed by the processor 112 to the inspection device 12 such that a wireless transceiver unit 121 can receive the analyzed signals and then store them in a database 122 as the comparison references for subsequent detections. Consequently, it should be noticed that all structures and devices capable of achieving the aforementioned effects are covered by the scope of the present invention, so all such modifications and equivalently structural changes reasonably fall within the scope of the present invention.

As such, the present invention essentially provides an inspection method for early warning system of industrial security, in which it applies a non-contact sensor of a inspection tool to detect a predetermined area, transfers the inspected signal characteristics to a processor for analyses in order to determine whether an abnormal signal occurs therein such that relevant precautionary operations may be executed in that area thereby enhancing the industrial security and reducing the possibility of industrial security accidents. In this way, the inspection processes may require less manpower and lower budgets, thus offering benefits such as time-saving, work-saving and economical effects, and the inspection tool can repeatedly operate to inspect within short period of time, thereby allowing precise analyses on industrial security inspections for industrial factories, precautionary operations and reduction of damages and losses caused by accidents. The above-mentioned illustrations, however, is merely the preferred embodiments of the present invention, rather than accordingly to limit the scope of the present invention. Therefore, it can be appreciated that all convenient modifications and structural variations of equivalent effects based on the contents of the specification and appended drawings should be reasonably deemed as falling within the scope of the present invention.

In summary, the aforementioned inspection method for early warning system of industrial security according to the present invention is capable of, in implementation and practice, achieving the aforementioned effects and objectives thus demonstrating the values thereof with regards to usefulness and innovation and fulfilling the requirements on patent applications, so the present application is herein submitted based on relevant regulations in order to legally protect the inventor's efforts for the present invention. Should there be any questions or instructions from the examiners of your Office, the inventor of the present invention will be very pleased to cooperate and provide any further information concerning the present application in details.

What is claimed is:

1. An inspection method for early warning system of industrial security, comprising the following inspection steps:
(a) using a non-contact sensor of an inspection tool to collect relevant signal characteristics with regards to the periphery of a predetermined area;
(b) calculating on the collected signal characteristics by means of a processor in the inspection tool through the predetermined programs;
(c) determining, based on the calculation results, the error point of the signal characteristics by means of the processor in the inspection tool;
(d) the processor determining the time that an abnormal phenomenon is about to occur in accordance with the data of the error point, sending out the signal characteristics in advance, and transmitting the signal characteristics via a wireless transmission unit;
(e) receiving the signal characteristics transmitted by the wireless transmission unit by using a wireless transceiver unit of an inspection device and storing in a built-in database for subsequent comparisons.

2. The inspection method for early warning system of industrial security according to claim 1, wherein the non-contact sensor of the inspection tool in Step (a) is an infrared (IR) sensor, a hygrometer, a photo-sensor, a dust monitor or an air detector.

3. The inspection method for early warning system of industrial security according to claim 1, wherein the predetermined area in Step (a) refers to the central control room, the power distribution system, the air conditioning system, the machining tool, the working mother machine or the electrical apparatus of a factory, and the signal characteristics for the periphery of the predetermined area include temperature, humidity, air concentration, or otherwise foreign substance or dust content in the air.

4. The inspection method for early warning system of industrial security according to claim 1, wherein the predetermined programs in Step (b) include the Z-transform formula:
$$X ( z ) = Z \{ x ( n ) \} = {\sum }_{n = 0}^{∞} x ( n ) {z}^{- n .} .$$

5. The inspection method for early warning system of industrial security according to claim 1, wherein the processor of Step (b) is further electrically connected to a storage unit for storing the signal characteristics as well as a warning unit capable of issuing warning signals.

6. The inspection method for early warning system of industrial security according to claim 5, wherein the warning unit is an alarm lamp, a buzzer or a speaker.

7. The inspection method for early warning system of industrial security according to claim 1, wherein the wireless signals transmitted between the wireless transmission unit in Step (d) and the wireless transceiver unit in Step (e) conform to the specifications of Zigbee, Z-wave, Bluetooth, Wi-Fi, WiMAX, light communication or Sub-G.

8. The inspection method for early warning system of industrial security according to claim 1, wherein the inspection device in Step (e) compares and analyzes the environmental temperature, voltage, current or wireless signal intensity in the inspected area based on the predetermined data built in the database, and further determines the difference from the predetermined data signals thereby compensating the difference signals between the components of each tool or equipment and facilitating auto-corrections of the inspection tool.
